(19) United States
(12) Patent Application Publication
(10) Pub. No.: US 2009/0122761 A1
(43) Pub. Date: May 14, 2009

(54) Personalised Heterogeneous Network Handover Alert Scheme

(76) Inventor: David E Hughes, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 11/990,270

(22) PCT Filed: Aug. 25, 2006
(86) PCT No.: PCT/GB2006/003183

§ 371 Date: Feb. 11, 2008

(30) Foreign Application Priority Data
Aug. 31, 2005 (GB) 0517711.8
Aug. 31, 2005 (GB) 0517712.6
Aug. 31, 2005 (GB) 0517715.9

(51) Int. Cl. H04W 4/00

(52) U.S. Cl. 370/331

(57) ABSTRACT

A communications system comprising a plurality of local area networks (LAN) within a wide area network (WAN). The mode of communication used in said LANs differs from the mode of communication within said WAN. One of the LANs comprises a home LAN which is associated with a user identity (e.g. a subscriber for that LAN in the communications system). The user identity is directly or indirectly also associated with a wide area network. The invention provides a method of configuring an alert to devices operated by other user identities which have performed a handover operation either into or from said home network of the subscriber. The alert is configured by said subscriber (e.g., by a user identity of the home network) either as a default to all ‘visitors’ or in dependence on one or more of the other user identities. In this way, each user identity visiting the subscriber's home network receives an alert which is capable of being specific to the visitor. The subscriber may select the form of alert to be provided to another user based individually on the other user's identity in the communications network or for a group of users. The method thus enables alerts to distinguish different users or groups of users. The form of alert provided may over-ride any personal preferences configured for the mobile communications devices of the visiting users.

The present invention relates to a personalized heterogeneous network handover alert scheme and related aspects. In particular, but not exclusively, the invention relates to a scheme for a personalized heterogeneous network handover notification to alert a user to a handover event between different types of networks in a heterogeneous communications system.

One example of a heterogeneous communications system is a wireless communications system comprising a plurality of short-range local area networks and one or more long-range wide-area networks. In such a communications system, examples of heterogeneous handover events include when a handover request message is generated by a mobile communications device of the user and when the handover has been completed.

Mobile communications networks are typically used by devices which have different characteristics to the cordless devices provided for use with fixed line communications networks. Mobile communications devices, for example, cellular telephone handsets, typically use Subscriber Information Module (SIM) cards to provide a unique user identity which associates the communications device with a wireless wide area network, for example, a cellular communications network. The SIM enables the user of the mobile communications device to be identified by the network associated with the user identity for billing purposes, and other identifiers are also provided to recognize the communications device within the network. For example, SIM cards are used in the Global System for Mobile (also known as Group Speciale Mobile) or GSM network, which provides a standard for digital cellular communications within Europe and other territories, which is well known to those of ordinary skill in the art.

A mobile communications device can perform a handover between different GSM wide-area networks when it leaves an area serviced by one network if the mobile communications device has been enabled by the relevant network operators to “roam” in the other network. Calls made in the different network are typically charged at a more expensive rate than those in the user's home network. To alert the user to the presence of the different network, it is known to provide a notification when the user is in the new network coverage area. This notification may be provided by means of a change of background display indicating the network operator/service provider of the new network and/or by sending out a small message service (SMS) text message to the user's mobile handset. All alerts are sent in the same generic format to all mobile communications devices in the new network, regardless of whether any specific individual device can use that network or not.

An example of a wireless local network associated with a fixed calling line identity of a fixed line subscriber which is well known in the art is the wireless network used by DECT, the Digital Enhanced Cordless Telecommunications 2^{nd} generation European cordless standard. This standard digital cordless telephony is based on advanced time division multiplex access (TDMA) technology. DECT was developed by ETSI for domestic cordless telephone service but now extended to other uses as well such as telepoint and data transmission in office environments (wireless LAN). DECT operates in 1.88-1.90 GHz band and uses TDMA coding.

Recently, technical advances in short-range wireless communications have enabled other short-range radio frequency transmission networks to be deployed, such as that known as Bluetooth™. Bluetooth™ is a short range radio technology which was devised to simplify data synchronisation between internet devices and computers and for communications among devices using the Internet.

At present, DECT telephones are not compatible with mobile telephone networks and vice versa, which results in users having to subscribe to both a mobile network provider and a wired (fixed) network provider and to have both a mobile telephone number and a home number associated with the fixed network (which may be used by a cordless phone). If a user is using a cordless (e.g. DECT-type) telephone device to make a call, the range of such phones is typically only a few hundred meters at best, and if they were to move out of range of the cordless phone, they must hang up on the call. If they wish to continue the communication using a mobile communications network, the user must re-call the call recipient using a separate mobile telephone device. This is obviously very burdensome and tedious, and results in duplication of telephony equipment and requires use of two subscriber identities/calling line identities (as subscribers are identified in a mobile communications network by their SIM and in a wired communications network by calling line identity).

To obviate and or mitigate the disadvantages of either not providing any alert or simply providing a generic alert to all users of similar mobile communications devices when a handover is performed, in the system and method of the invention, a mobile communications device for use with the invention is capable of transferring calls between homogeneous and/or heterogeneous networks, i.e., networks which have different transmission characteristics, such as range, in which handover alerts are provided which are personalisable by the user of a mobile communications device and/or a subscriber associated with the local area network (LAN) to or from which handover is requested. Whilst such transfers could be performed transparently (particularly if the device is in active use), according to the invention, the user is alerted to the change of networks using alert means which either the user can personalize or which the subscriber has personalized for other users.

The present invention seeks to provide a communications system and associated aspects which enable a subscriber to personalize the alert provided to other users when the mobile communications devices of said other users enter and/or leave the area covered by the subscriber's LAN.

The handover alert is personalized by the subscriber selectively controlling the form of the announcement sent to other users of the communications system when their devices request a handover to or from the subscriber's LAN.

One embodiment of the present invention also seeks to provide a mobile communications device which is associated with an identity which is capable of routing communications over both a short-range network which interfaces a fixed network (in which a calling line identity may be directly or indirectly associated with the user) as well as over a long-range wireless communications network (in which a subscriber identity and/or device identity is associated with the user).

The term mobile communications device will be used to refer to any mobile communications device capable of using a communications network such as a telephone, personal digital assistant, computer etc.

The term SIM, when used in the context of the invention, refers to any suitable form of user identity, including real and virtual and embedded means of user identification providing the necessary means of enabling a device according to the invention to be recognized in more than one type of network may be used.

The term alert refers to an alert which is displayed on a communications device capable of communicating using a plurality of communications modes, one mode associated with a short-range network (referred to herein as a LAN) the other mode being associated with a long-range network (referred to herein as a WAN).

The alert is provided as a result of a mobile communications device generating a request for handover between two heterogeneous networks.

The alert may be provided to the user either when the request is generated or when the handover has been completed and the communications device operates using a differing communications mode to the mode used prior to generating the handover request.

The invention enables personalization of alerts associated with one or more events of the handover operation.

Firstly, personalizing the event associated with the mobile communications device issuing a request message for the network handover, such as may occur automatically when the quality of service (QoS) in the current network is less than acceptable.

Secondly, personalizing the notification message sent to mobile communications device identifying which network the device is in after the handover has occurred.

Thus the term alert may refer to an alert triggered by the request for handover and/or the actual completed handover.

Those of ordinary skill in the art will find apparent that if specific reference is made to one form of alert being triggered by a particular form of network event, any equivalence to the form of alert triggered by the other form of network event exists only where those skilled in the art are able to adapt one form of alert associated with the first type of network event to an alert suitable for the other type of network event.

One aspect of the invention seeks to provide a method of providing an alert in a communications system comprising a plurality of wireless local area networks and a wide area network.

The alert is provided to a mobile communications device associated with an identity. The identity is a user identity and/or a device identity, at least one of which is suitable for use in both a short-range local area network and/or a long-range wide area network.

The mobile communications device is capable of operating in two modes of communication. One mode is associated with a local area network of said communications system. The other mode is associated with the wide area network of said communications system.

The method of this aspect comprises: determining the presence of another wireless network within which said mobile communications device operates using a different mode of communication. An alert is triggered when a network handover event occurs.

The steps for triggering said alert comprise the mobile communications device: generating a handover request for performing a heterogeneous network handover either to or from a wireless local area network; and generating a personalized alert associated with said heterogeneous network handover event on said mobile communications device.

The wireless local area network to or from which handover is performed will generally be associated with a subscriber other than the user of the mobile communications device. The method may in one embodiment, first require determining one or more criteria for requesting handover to said alternative wireless network are met.

In one embodiment, said heterogeneous network hand over event comprises generating said request.

In one embodiment, said heterogeneous network hand over event comprises completing a handover to or from said local area network.

In one embodiment, said method further comprises the steps of: receiving said request at a wireless router supporting said wireless local area network of said subscriber, and processing said request to determine the identity of a requesting mobile communications device.

In one embodiment, in said step of processing said request, if said request is associated with a user identity which is not the identity of the subscriber, the method further comprises the steps of:
retrieving from a data store information indicating an alert mode associated with said user identity; and
communicating information to said mobile communications device to enable said mobile communications device to generate a personalized alert.

In one embodiment, said information is communicated to the mobile communications device using a LAN communications mode.

In one embodiment, said information is communicated to the mobile communications device using a WAN communications mode.

In one embodiment, the alert indicates that the mobile communications device is within the area of service of a wireless local area network associated with a subscriber of a network service, wherein said subscriber's user identity differs from said user identity associated with said device, and

In one embodiment, said device further comprises means to request a handover between heterogeneous networks of said communications system both on-hook and off-hook,

In one embodiment, the method further comprises the step of said subscriber configuring said alert mode by associating an alert mode with one or more user identities in said data store.

In one embodiment, the form of the alert is personalized by the subscriber and is generic to any device which is within the area serviced by said local area network of the subscriber.

In one embodiment, the form of the alert is personalized by the subscriber and is determined by the subscriber for a specific user or group of users.

In one embodiment, the form of the personalized alert includes an indication of whether the subscriber has enabled said user device to use one or more services of the subscriber's local area network.

In one embodiment, the form of the alert comprises not sending any indication to the visiting user's device to indicate the presence of the subscriber's network.

In one embodiment, said configuration step comprises the steps of: the subscriber associating an alert with an identity associated with the mobile communications device of another user, whereby, when said device of said other user enters said subscriber's local area network, said alert personalized by the subscriber is provided to said other user's mobile communications device.

In one embodiment, said personalized alert comprises a media file, wherein when said mobile communications device generates a request for handover to said subscriber's network, said media file is executed on said mobile communications device.

In one embodiment, said executed media file comprises at least one form of the following media: one or more images to be displayed on the user's device; one or more audio files to be played on the user's device; one or more video files to be played on the user's device; and/or a physical response in the user's device.

In one embodiment, said media file is communicated to said other user's mobile communications device from a server of said subscriber over said subscriber's local area network.

In one embodiment, a differing alert is provided to said mobile communications device when said mobile communications device performs a handover to said local area network from said wide area network, from when said mobile communications device performs a handover from said local area network to said wide area network.

Another aspect of the invention seeks to provide a communications system comprising a plurality of wireless local area networks and a wide area network and a mobile communications device associated with a user identity, wherein said mobile communications device is capable of operating in two modes of communication, one mode being associated with a local area network of said communications system, the other mode being associated with the wide area network of said communications system, communications system comprising in said mobile communications device:
means for determining the presence of another wireless network within which said mobile communications device operates using a different mode of communication; means for determining one or more criteria for requesting handover to said alternative wireless network are met;
means for generating a handover request for performing a heterogeneous network handover either to or from a wireless local area network associated with a subscriber other than the user of the mobile communications device; and
means for generating a personalized alert associated with a heterogeneous network handover event on said mobile communications device.

Another aspect of the invention seeks to provide a mobile comimunications device associated with a user identity, wherein said mobile communications device is capable of operating in two modes of communication, one mode being associated with a local area network of a communications system, the other mode being associated with the wide area network of said communications system, the mobile communications device comprising; means for determining the presence of another wireless network within which said mobile communications device operates using a different mode of communication; means for determining one or more criteria for requesting handover to said alternative wireless network are met; means for generating a handover request for performing a heterogeneous network handover either to or from a wireless local area network associated with a subscriber other than the user of the mobile communications device; and means for generating a personalized alert associated with a heterogeneous network handover event on said mobile communications device.

Another aspect of the invention seeks to provide a communications system, comprising a plurality of wireless local area networks, and a wireless wide area network, wherein each local area network is capable of providing an alert to a plurality of communications devices, wherein each said communications device is capable of operating in a first mode within a local area network and, a second mode within said wide area network and of handing over between at least one of said local area networks and said wide area network, the communications system comprising for each mobile communications device of a user:
means to send and receive communications to said device in said local area networks and said wide area network; means to process handover requests received from each user's mobile communications device when said device seeks to perform a handover in either direction between said wide area network and a said wireless local area network associated with a subscriber; means to identify a local area network associated with said handover request; means to determine an identity for the user of the mobile communications device; means to communicate said identity to the router for said local area network associated with said handover request; wherein the communications system further comprises: means to determine if an alert to be communicated to said mobile communications device has been configured on said router, and if so, means to communicate said alert to said device, wherein the form of said alert to said user identity is determined by said subscriber and stored at a location accessible to said router for said subscriber's local area network.

Another aspect seeks to provide a computer application arranged to provide personalized alert information to a user operating a mobile communications device in a local area network associated with a subscriber to a communications system, wherein the application is arranged to enable the subscriber to select one or more differing kinds of announcement to alert each user of a visiting device in dependence on the identity of said user of a visiting device, wherein said application enables an association to be formed between said identity, said home network of the subscriber, and the form of alert selected by the subscriber for said user. The application may be provided using any known suitable platform having appropriate processing and interface means.

In one embodiment, the computer application is distributed over a plurality of platforms in a communications system, and the application further comprises: selection means to enable the subscriber to select an alert in association with another user's identity located on a first platform, wherein said first platform provides means to communicate said alert association to a remote platform of said communications system, wherein when a request to perform a network handover from a mobile communications device of said other user is received at said remote platform of said communications system, said remote platform causes said alert to be communicated to said mobile communications device of said user.

In one embodiment, said selection means is provided on said mobile communications device of said subscriber and information on a selected association of user identity and alert mode is communicated to said first platform by said mobile communications device of the subscriber using a wireless communications network.

In one embodiment, said first platform is arranged to communicate said alert configuration to said remote platform over a fixed-line communications link.

In one embodiment, said user's identity is determined by a telephone type number or identity which is associated with an alert configuration by said subscriber of said home network.

Another aspect of the invention relates to a mobile communications device capable of adopting two modes of wireless communication in a communications system, one of said modes being associated with a wide area network, the other of said modes being associated with a local area network, wherein the device further comprises means to request and perform a handover between said two modes of communication when both on and off-hook, and wherein when said device generates a request to handover between said local area and wide area networks, said request event causes an alert to be provided to a user of said device, wherein the mode of the alert has been configured by a different user, whose identity is associated with said local area network between which said handover has been requested.

In one embodiment, the method of providing the alert comprises the steps of any method aspect.

In one embodiment, said means for generating said alert mode are first communicated to the device using said local area network between which said handover to or from said wide area network has been requested.

In one embodiment, said alert mode generated when said device hands over to said local area network is different from the alert mode generated when said device hands over from said local area network.

In one embodiment, said device further comprises alert configuration means arranged to configure said alert information to be provided to one or more other users of other devices when said one or more other users are within a local area network of a subscriber.

In one embodiment, said alert configuration means comprises an application arranged to be executed on a mobile communications device of the subscriber, said application being arranged to enable the subscriber to generate an alert association associating a form of alert with an identification of another user of said communications system, whereby said selected form of alert is sent to the other user when a mobile communications device of said other user has handed over to or from the home network of said subscriber, said application being further arranged to communicate said alert configuration means over said communications system to a server via a router for said local area network, wherein said alert configuration means associates said alert configuration with handover events associated with said home network.

Another aspect of the invention seeks to provide a server arranged to provide alert information to a mobile communications device via a wireless communications network router, when the mobile communications device has handed over from a first type of wireless communications network to a second type of wireless communications network associated with said router, wherein said alert information which is communicated to the device of a user over said second type of communications network comprises an alert which has been configured by a subscriber to said second type of communications network using any application aspect.

Another aspect of the invention seeks to provide a signal communicated from a router associated with a local area network in a communications system comprising a plurality of wireless local area networks and a wireless wide area network, wherein the signal is received by a mobile communications device operated by a user in said communications system, said mobile communications device being capable of performing a handover between at least one said local area networks and said wide area network, and said device further comprises means to send and receive communications in a communications mode used by said local area networks and a communications mode used by said wide area network, wherein said signal enables an alert to be generated by said mobile communications device to alert the user to the fact that a handover to or from the local area network has been performed or requested, the mode of the alert having been determined by a user associated with said local area network.

One embodiment enables a user to configure the alerts so that when handover into a short-range network occurs, the user is able to personalize that alert. The short-range network may or may not be the short-range network associated with the network identity of the user (for example, with the SIM-type device installed in the user's mobile communications device).

One embodiment enables the user to configure the announcements differently depending on whether a hand-over is for a device moving into the short-range network or leaving the short-range network.

One embodiment enables the user to configure their own short-range network to personalize the announcement sent to other devices if they enter that user's own short-range network.

One embodiment enables the user to configure their own short-range network to personalize the announcement sent to selected other mobile communications device subscribers to enable said subscribers to use that user's own short-range network.

One embodiment enables the user to personalize an alert associated with a request handover event being generated on a mobile communications device.

One embodiment enables the user to personalize an alert associated with a post-handover announcement that the user is now in a particular network.

One embodiment enables in a communications system comprising a plurality of local area networks (LAN) within a wide area network (WAN), wherein the mode of communication used in said LANs differs from the mode of communication within said WAN, and wherein one of said LANs comprises a home LAN is associated with a user identity (e.g. a subscriber), which is also associated with a wide area network, the provision of a method of configuring an alert to devices operated by other user identities which have performed a handover operation either into or from said home network, wherein said alert is configured by said user identity of said home network in dependence on one or more of said other user identities, such that each user identity visiting another user's home network receives an alert which is capable of being specific to the user. The user of the home network may select the form of alert to be provided to another user based on the other user's identity in the communications network, so as to distinguish the alerts provided to different users or groups of users. The form of alert provided may over-ride any personal preferences configured for the mobile communications devices of the visiting users. The term “subscriber” is used herein to refer to a user identity which is capable of configuring alerts to visiting devices in a particular LAN. As such the “subscriber” identity may not be limited to a specific individual in any one LAN, but refers to any individual user identity which has this capability.

Those skilled in the art will appreciate that any appropriate combination of the preferred embodiments as set out above and in the accompanying dependent claims can be combined with any appropriate combination of the aspects of the invention set out above and in the accompanying independent claims.

The preferred embodiments of the invention will now be described with reference to the accompanying drawings which are by way of example only, and in which:

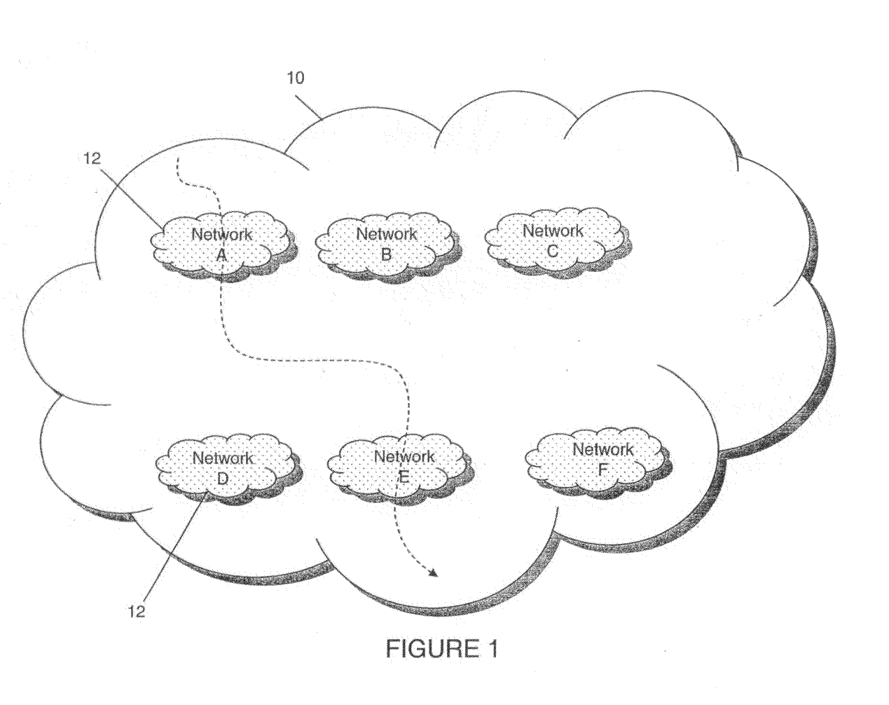

FIG. 1 shows a communications system comprising a plurality of heterogeneous networks;

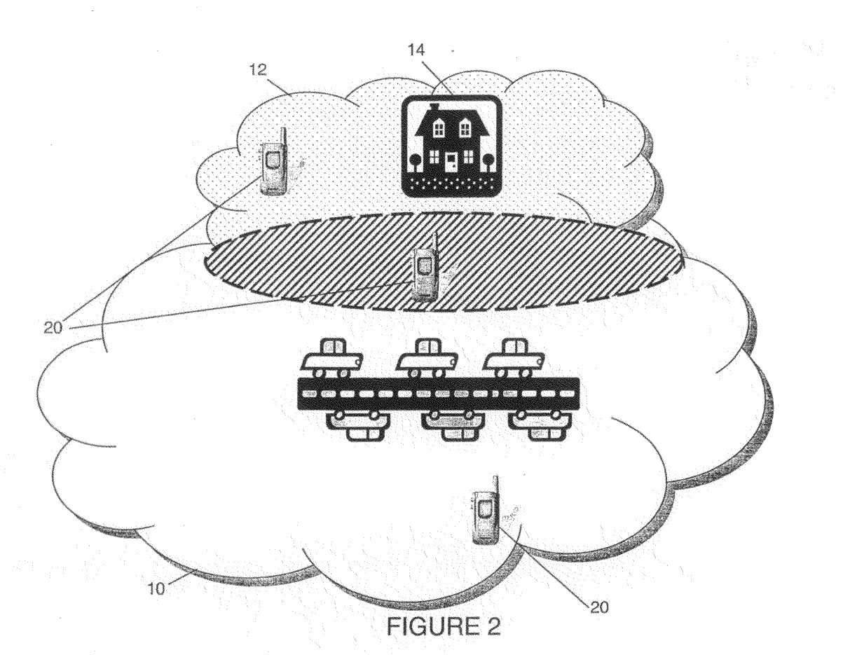

FIG. 2 shows in more detail, the transfer region between two heterogeneous networks where a personalized network event notification is generated according to the invention;

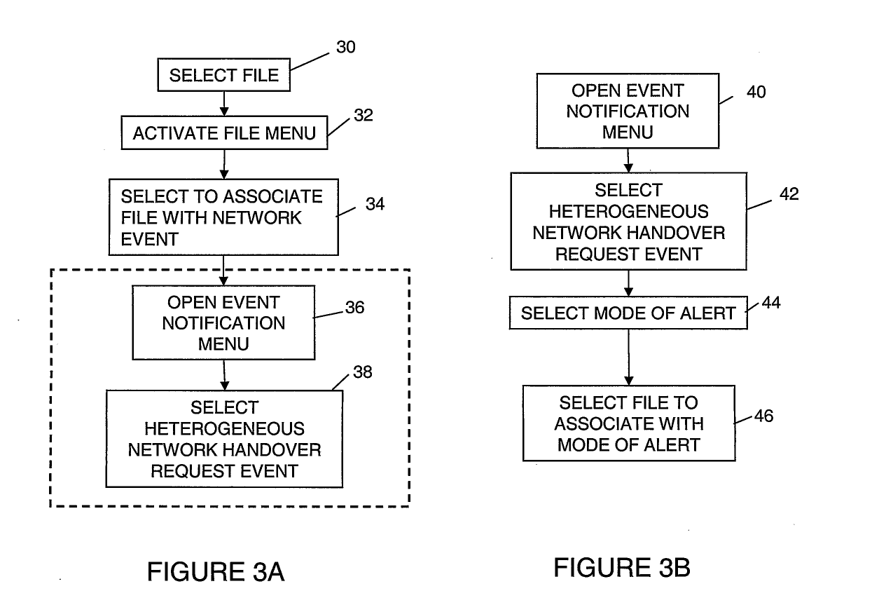

FIG. 3A shows steps in a method of personalizing a network event notification according to an embodiment of the invention;

FIG. 3B shows steps in a method of personalizing a network event notification according to another embodiment of the invention;

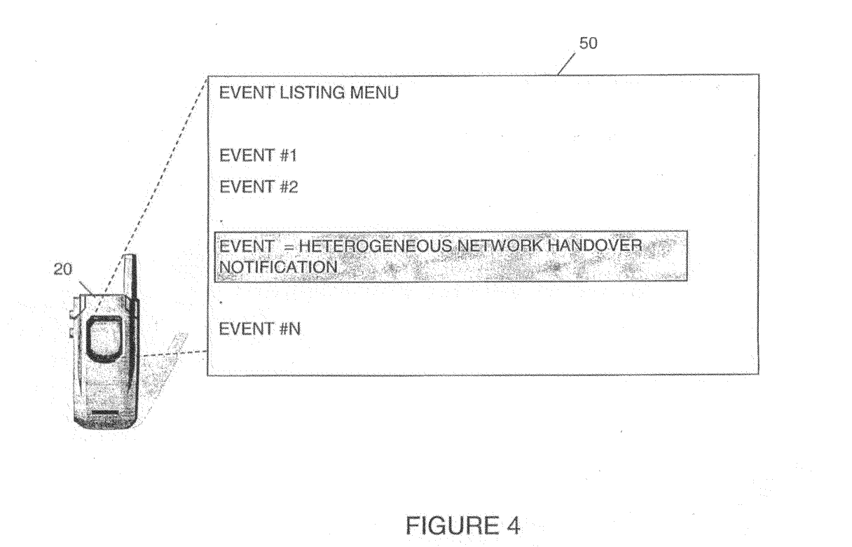

FIG. 4 shows an exemplary event listing menu according to an embodiment of the invention;

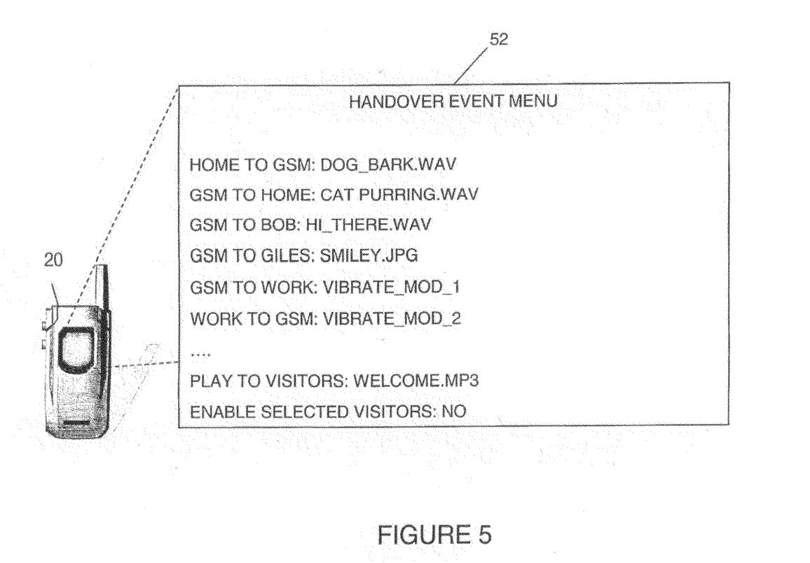

FIG. 5 shows an exemplary handover event menu according to an embodiment of the invention; and

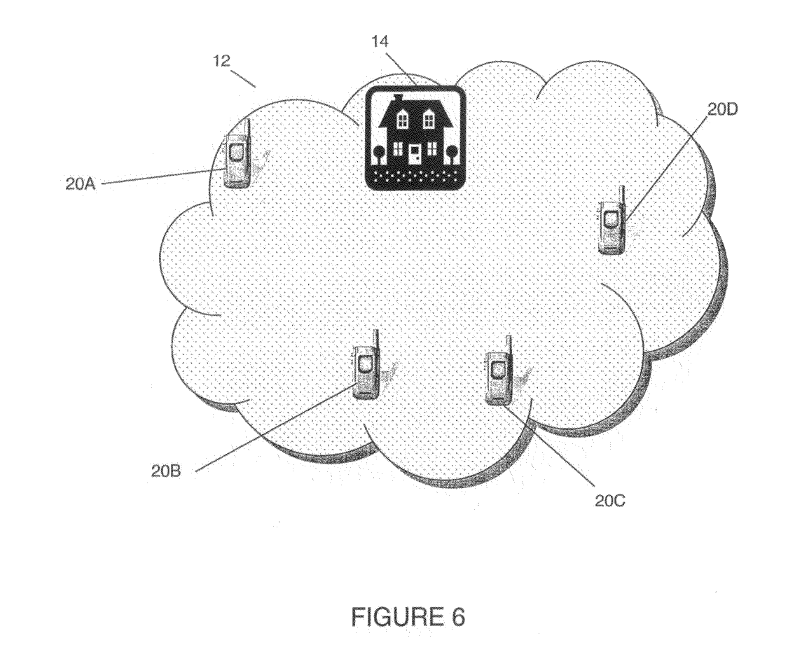

FIG. 6 shows an example of how a subscriber to a network can configure differing alerts to differing other devices when said other devices are in said subscriber's home network.

The best mode of the invention as currently contemplated by the inventor will now be described with reference to the accompanying drawings. Those skilled in the art will realize that the drawings omit for clarity many features of the invention, and that the drawings show primarily features which are not apparent and/or which are essential to the invention.

A heterogeneous communications system is shown in FIG. 1 of the accompanying drawings, as communications system 1. Communications system 1 comprises a wide area network (WAN) 10 and a plurality of local area networks (LANs) 12. WAN 10 has differing characteristics to LANs 12, and mobile communications devices 20 (not shown in FIG. 1) of said heterogeneous communications system operate in differing communications modes depending on whether they are within WAN 10 or in LAN 12. A dual mode mobile communications device according to one embodiment of the invention is capable of performing a handover both on-hook and off-hook (i.e., both when being actively being used for communications and when setting up such communications, or in a state capable of receiving instructions for such communications (i.e., when a dial-tone is generated)). An example of such a device is marketed as BT Fusion™.

Typically, the communications mode within WAN 10 is suitable for long-range communications, e.g. a cellular e.g. (Global System for Mobile) GSM network. The communications mode within the LAN is typically an unlicensed mobile access (UMA) mode of communication, for example, which is capable of providing access to the WAN 10. Alternatively, communications may be session based (for example, supported by the session initiation protocol (SIP)).

WAN 10 covers a sufficiently large geographic region for the network coverage provided by each of the plurality of LANs 12 shown in FIG. 1 to be entirely contained within WAN 10. A subscriber (i.e., a user) of the communications system will be provided with a mobile communications device associated with a home LAN, i.e., the user will have a unique subscriber identity associated with their own home LAN. This user identity is also associated with the WAN in the communications system shown in FIG. 1.

This association is achieved in one embodiment of the invention by providing dual subscriber identities on the mobile communications device of the user. Alternatively, the user identity may be associated in both the WAN and in the user's home LAN by embedding the user identity for the LAN within the user identity of the WAN (or vice versa).

In one embodiment, a user identity is capable of being associated with both a WAN 10 and one or more LANs 12 (at least the user's own home LAN and preferably, but also in the WAN and in other user's LANs). Whenever the user's device determines that a handover between a WAN and a LAN (or vice versa) is possible, it will generate a handover request event message, and communicate this either to the router associated with the LAN the device is just entering or leaving, or to a base station associated with the WAN. This request will trigger an alert to be provided to the user. In one embodiment, the alert is configured by the user in accordance with a particular LAN (i.e., either the user's own LAN or. with another user's LAN). An alert can be generically personalized by the user (any handover causes a tune to be played), or made specific to a handover request to or from a particular LAN (in which case the mode of alert depends on identifying the LAN and/or the associated subscriber identity for that LAN. Additionally or alternatively, the alert may be configured by the subscriber and provided to other user's of. the communication system who visit the subscribers LAN (i.e., to devices who generate a request to handover to the subscriber's LAN).

In the exemplary embodiment of the invention. shown in FIG. 1, dual-mode communications system 1 comprises a wireless WAN 10 and a plurality of wireless LANs 12, of which six LANs At to F are shown. Those in the art will appreciate in practice any number from one to, for example, several hundred thousand LANs 12 may be provided in practical implementations of the invention. The characteristics of each LAN 12 include an area of coverage which is associated with a fixed geographic point (i.e., each wireless LAN is supported by a wireless router or wireless home hub platform, shown as router 14 in FIG. 2 of the accompanying drawings). The LAN located within the area of coverage of the WAN 10 and in one embodiment of the invention comprise short-range wireless LANs, such as might be implemented using a UMA mode of communications, e.g. a 802.11 standard (e.g., WiFi, or WiMax), but preferably is a short-range radio network such as that conforming to the Bluetooth™ standard, or any communications protocol which is capable of enabling a mobile communications device operating in such a mode of communications to access WAN 10 when both on-and off-hook.

An exemplary embodiment will now be described in terms of a path a user may take whilst using a dual-mode mobile communications device 20 in the communications system 1 of the invention. This is shown as a dotted curved line shown in FIG. 1, in which a user of the mobile communications device 20 moves along a path from a first LAN (A) (for example, their own house), to another LAN (E), and on. Such a path requires the mobile communications device of the user to generate several requests for handover, firstly from LAN A to WAN 10, secondly from WAN 10 to LAN E, from LAN E to WAN 10. to perform This path will be referred to in more detail laterhereinbelow.

As mentioned above, each mobile communications device in a communications system according to the invention has the capability of receiving and transmitting information in at least two modes of communication, one associated with LANs 12, the other with WAN 10. Means for handing over between heterogeneous networks (i.e., between LANs 12 and WAN 10 and vice versa) are also provided on each device. The capability to “perceive” and/or to “roam” in other LANs 12 is optionally provided in some embodiments of the invention. The ability to use a mobile communications device in a plurality of LANs may be a default for a device, and/or require the user to firstly subscribe to a “roaming option” type service. In one embodiment “roaming” is optional only if a subscriber associated with the LAN the mobile communications device is to roam in has configured the LAN accordingly. Such “Visiting” mobile communications devices may receive alerts which are a result of handover requests being generated, but unless the mobile communications device is able to use the LAN to which the handover has been requested to, all the user will receive is an alert signifying they are effectively in a specific geographic area, as they will not be able to use the LAN—i.e., although the user is within the area of coverage provided by the LAN network, their device will continue to communicate using the communications mode associated with WAN 10.

A handover network event can be personalized in a number of ways.

Firstly, a user can program their own device to associate the request network handover event with a personalized alert, such as a particular image or video or audio file to be executed. Examples would be to associate the home network with an image of a family, to play an announcement such as “Welcome Home”, or to vibrate. This event message could be associated with all heterogeneous network handovers.

Secondly, in an other embodiment of the invention, the user could associate a network handover request message associated with a particular network identity (for example, if they associated the handover to the home network of another user whose number details were stored in association with that network's identity) to personalize the alert in a different manner (e.g., to play a sound saying “You're at Granny's”), or to display an image of “Granny” on the mobile communications device display.

The third manner of personalizing the heterogeneous network handover is for the user to generate a personalized message to alert other users of similar devices, to the fact that they have entered his or her home network, (i.e., to a network for which the user has a “subscriber status”) e.g., to play a sound indicating “You're at Bob & Carol's”, and to send automatically a picture say of the family pet to the screen of the visitor's mobile communications device, when the other user's device generates a request to handover to that home network of the user.

In FIG. 2 of the accompanying drawings, WAN 10 is shown below a LAN 12. A LAN 12 generated using a wireless router 14 provided in a subscriber's home or other premises, this subscriber associated LAN is referred to as a “home network” or equivalently as a “home LAN” herein. The term “home network” is used to refer to all LANs associated with subscribers in the sense they are associated with a geographic area of coverage associated with the subscriber's home (or equivalently with work premises, or with a shop premises, or restaurant, or hospital, or other premises etc). Outside the home network 12 area of coverage, WAN 10 provides one or more communications services to mobile communications device 20, whereas inside the subscriber's home LAN, the LAN provides one or more communications services. In some embodiments of the invention, mobile communications device 20 is also able to receive one or more communications services within the LANs of other subscribers to the communications system.

On the lower side as shown in FIG. 2, at a first position, mobile communications device 20 is wholly within the WAN 10. On the upper half of FIG. 2, at a third position, mobile communications device 20 is shown wholly within the area covered by LAN 12. In an intermediate position, such as is indicated by the hashed boundary region 16 shown in FIG. 2, mobile communications device 20 is in a state of handover between the two networks.

As mentioned hereinabove, a heterogeneous network transfer event has two stages. Firstly, a request is issued by the mobile communications device to request handover.

When this request is generated the mobile communications device is still communicating using a mode of communication associated with the pre-handover network. Secondly, after the handover has been completed, a notification is issued to indicate the user is in the second network. After handover, the mobile communications device uses a different mode of communication to the first, the different mode of communication being used within the second network.

In one embodiment of the invention, the user is able to personalize an alert which is associated with the request issued by the device for handover to a different network. In an alternative embodiment of the invention, the user is able to personalize an alert indication identifying when the mobile communications device is within the area of cover of the new network. This alert can indicate that either simply that the LAN exists (i.e., it may comprise an advertisement which has been configured either by the user of the mobile communications device, or by the subscriber to the other LAN), or that handover has been successful, or that one or more services and/or characteristics of the LAN are available.

A number of alert modes are possible, including individual or combinations of alerts, for example, audio, visual, video, tangible (e.g., vibration) etc. The alerts are activated by associating data with the relevant network event using an appropriate application. In one embodiment of the invention, an alert is dependent on the direction of the handover (i.e., depend on whether the user is arriving into the LAN or leaving it). An alert is in one embodiment configured by a user of the mobile communications device using the mobile communications device. Alternatively, an alert may be configured remotely and the configuration settings transferred to the mobile communications device when within the subscriber or other user's LAN, by means of data signals such as support file transfer and/or messaging services, or using appropriate means such as are well-known to those skilled in the art.

In a preferred embodiment of the invention, the mobile communications device 20 is provided with a user identity (e.g.. a SIM code) associated with a LAN mode of communications, e.g., with a short-range radio network such as Bluetooth™, which is capable of being associated directly or indirectly with a user identity for use in a WAN (e.g., within a GSM network). The term user identity as referred to herein refers to a single device/user operating a device, regardless of how the identity in practice is recognized within each network.

For example, referring back now to FIG. 1, as the mobile communications device moves along the dotted line shown, user identity associated the LAN “A” may differ from that of WAN 10, but nonetheless the two are associated together, enabling a unique user identity to be provided within both LAN “A” (or any other LAN 12 of the communications system) and WAN 10.

According to the invention, a handover event generates an alert either indicating when the communications mode of the mobile communications device has changed and/or when the mobile communications device has requested that the communications mode change. For example, along the path shown in FIG. 1, although the route taken is entirely within the network coverage of WAN 10, as mobile communications device 20 is capable of performing a handover between WAN 10 and LAN A, when mobile communications device 20 is within the area of cover provided by LAN A, the mobile communications device will operate using a different mode of communications to that used when it is within WAN 10.

Consider a user A whose “home network” is LAN A. In one embodiment of the invention, whenever user A is outside the area of cover provided by network A, the GSM network is the only network which can used by their mobile communications device (for example, such as is the case if the “LAN roaming option” has not been subscribed to by the user). This means that when the mobile communications device is in the area covered by other short range network E, the user A of the mobile communications device will continue to use the GSM network even when they are within range of network E.

In one embodiment, LAN E shown in FIG. 1 is configured to announce itself to “visitors” (i.e., other users of the communications system, associated with other home LANs), when the mobile communications devices of the “visitors” enters the area covered by LAN E. In one embodiment, a user associated with LAN E (i.e., the subscriber associated with LAN E) is provided with an alert when other mobile devices have requested (or completed) a handover to LAN E. This effectively enables a user to monitor visitors to the premises associated with their home LAN.

In another embodiment, a user (i.e., a “visitor”) is alerted when their mobile communications device is in the coverage area of LAN E as a result of their mobile communications device requesting to handover to E, regardless of whether such a request is successful or not. When generated solely as a result of a request being issued for handover by their mobile communications device, the alert provided to the user is an indication of the extent of LAN E.

It is possible for the user of a mobile communications device in one embodiment of the invention, to configure their mobile communications device to generate alerts which are specific to one or more LAN identifiers, i.e., to general a specific alert indicating LAN E, and/or to provide a default alert for all other (non-home) LANs. Alternatively, in another embodiment of the invention, such an alert is configured by the user for whom E is the home network. Again, this alert may be specific to user A and their device or be generic to all visitors.

By providing an alert to the user, which either the user could configure or the subscriber responsible for network E could configure, the user would know that network E exists. To give some examples of such a personalized alert, this could be very helpful to children (e.g. “Welcome to Granny's”) in which case the “Granny” could configure a personalize announcement to be sent to the mobile communications devices of the children. However, a more generic announcement could be given instead to other mobile communications devices, e.g. “Mrs. SoAndSo”. The ability to personalize and distinguish visiting devices means that generic announcements which might be useful for businesses, e.g. “X Restaurant” etc., might customize their announcements for repeat customers etc. Alternatively, a privacy mode could be adopted as a default to “visiting” devices. In an embodiment where user A is able to use their mobile communications device in LAN E, this is because the user has automatically rights to use any LAN in the communications system 1. In another embodiment, user A may subscribe to a roaming option which requires consent from the subscriber for each LAN within which they wish to have roaming rights.

In yet another an alternative embodiment of the invention, user E, who has a SIM associated with network E, has subscribed to a service which enables network E to allow other SIMs associated with other LANs to use network E if they are within the area covered by network E. This would mean for example, that if a user were to start a call at home network A, and continue the call as they crossed the road to their neighbors house (network E), the mobile telephony device used to make the call would handover twice, firstly heterogeneously between network A and GSM network 10, and secondly heterogeneously between GSM network 10 and network E. Thus, “Granny” may configure her home network to enable other devices (e.g. in the family) to use her home-network when within it. The availability of the “Granny” home network would be consistent with the announcement that the visiting mobile communications device is within the network coverage of the device.

To associate a network event with a particular alert mode, a user interface is provided which configures the mobile communications device to appropriately associate a type of handover event with another action such as playing a sound file/displaying an image etc. The user interface can be provided on the mobile communications device or another platform which is capable of interfacing with the wireless router of the subscriber's LAN to remotely configure the subscriber's or other user's mobile communications devices who are seeking to handover to the LAN. The user-interface can either take a form where a user selects an option (or alternatively a file) which they associate with a particular handover event (see FIG. 3A) or a menu is provided which enables the user to associate an event with a particular file (see FIG. 3B).

According to one embodiment of the invention, the user associates the network handover request event and/or personalize network identification alerts with an appropriate media file. An appropriate file is capable of being executed on the user's mobile communications device. Examples include image files, movie files, audios files (e.g., sound-clips), and files associated with other forms of alert such as activation of light indicators and/or a vibration alert. Examples of different types of files include files of the form .jpg, .mp3, .wav, .wmp, etc. These media files may be generic or specifically provided for the device network identification and heterogeneous handover alert purpose, and may be generated by the user storing files they have created themselves (e.g., a voice recording), or which have been downloaded from a server either on a pay-per-go or via a subscription service etc. In one embodiment of the invention, the audible alert comprises any suitable audible media such as can be played on the user's mobile communications device, which may vary from a simple tone, or ring-tune to a polyphonic tune. In an alternative embodiment of the invention, the user is able to upload to the mobile communications device a configuration for the heterogeneous handover event notification and/or any subsequent indications of which network the mobile communications device is in from a device with greater storage and/or processing capabilities, such as a home computer.

Referring now to FIG. 3A in more detail, this shows schematically a configuration scheme for personalizing a heterogeneous handover alert in which a user selects a file (step 30), activates a file menu for that file (step 32), and then selects to associate the file with a network event (step 34). If the user has just a default alert for all network handover events, the process of personalizing their network handover event may terminate at that point. If the user has a more sophisticated system, for example, they could access optional menu options, such as might be the case if they wanted to distinguish between different short-wave networks, and/or whether they are entering or leaving a short-wave network etc, then other menu options may be presented or opened in a hierarchical format. The optional steps of opening an event notification menu (36) and selecting a specific heterogeneous network handover event (step 38) are shown within the dotted boundary shown in FIG. 3A. The ability to associate a file with a network event may be provided whenever a file is selected which is capable of being associated with an alert mode.

FIG. 3B shows in another embodiment the invention (which may be provided in addition or instead of the system shown in FIG. 3A), a configuration scheme for personalizing a heterogeneous handover alert in which a user first opens an event notification menu (step 40), selects an event (42), selects mode of alert (44), and then selects a file to associate with a mode of alert (46).

FIG. 4 of the accompanying drawings shows an embodiment of the invention in which a user is able to cause an event listing menu 50 screen to be displayed on mobile communications device 20. The user then employs the mobile communications device to associate a particular alert with a heterogeneous handover request event. As shown in FIG. 4, the event heterogeneous handover network event has been selected. The user may then select one or more different media files to be associated with the event of the device sending a request to perform a heterogeneous handover. As mentioned above, in one embodiment, an alert is generated only when handover is successful or alternatively, a second alert is provided to indicate successful handover. In one embodiment, this alert indicates the identity of the new network once the handover process has completed. The user may also provide “visitors” to their network with individual and/or generic announcements when they are in their network. Examples of such menu options are shown in FIG. 5. In FIG. 5, handover event screen 52 as displayed enables a user to select which one of a plurality of heterogeneous handovers they want to associated with a particular alert. In this case, the user has associated different .wav audio files to be played when they enter and leave home, and when they enter Bob's home network. When they visit Gile's home network a JPEG image file is displayed on their device. When they use their phone at work, the alert to the work network coverage is provided by a more discrete vibrate alert. They have a single default message to all visitors who all are able to see their home network “Welcome”. They have not enabled any visitors to use their home network.

In one embodiment, an alert is provided when a mobile communications call is actively taking place and has a form which enables it to be noticeable by the user of the mobile communications device involved in the handover. For example, any audio sound may be represented as a tone etc or any other form which is played in such a way that it is not transmitted along with other data when the mobile communications device is being used to place, an active call to the far end. This means that only the user of the mobile communications device will hear any audible alert as to which network they are in, and not the user of any device at the far end. Such an option may be configurable by the user, and is useful, for example, if the user does not want other persons to be able to associate the user with a particular location when they communicate. In one embodiment, the user configures different on-hook and off-hook alerts, and these different alerts in one embodiment distinguish between alerts provided to visitors and to the subscriber's mobile communications device.

Those skilled in the art will appreciate that to enable visitors to use a subscriber's home network—e.g. if someone is visiting their “Granny” etc, requires the subscriber to be capable of providing an appropriate indication to the router handing handover requests for that LAN that one or more services available in the home network to users already associated with that network should also be available to visiting devices. In one embodiment of the invention, such enablement occurs by default—any device capable of using a wireless broadband connection is capable of using any subscribers wireless broadband local area network, so that when a handover request is generated it follows by default that handover will follow unless the network overrides this. However, in other embodiments as mentioned above, successful handover is not assured—i.e., the device may request to handover, but in fact remains communicating using the wide area network mode of communication. Thus in some embodiments of the invention, the alert does not mean that the device is now able to use the local area network, such that the local area network exists and the device is now located within it.

Such embodiments may provide a selective service, and if so, the router associated with the local area network must be able to associate visitor's user identity as able to use said local area network (and/or to be able to use one or more services available over said local wireless network). This configuration may be performed in any appropriate manner already apparent to those skilled in the art. For example, the router may be configured to identity the user's identity directly by association with their mobile calling line identity equivalent, i.e., their SIM, or other identity uniquely associated with a user's device. In which case, the subscriber is able to associate services to be made available when configuring the alert they want to sent to the visitor when they hand over to the user's network (or when they request a handover—which may or may not be granted). Consider an exemplary embodiment where one or more SIMs is used by a mobile communications device to indicate the subscriber/ user identity for that device. In this case, when a router recognizes a visiting LAN SIM, the event could cause the router to push out a “Welcome” type of announcement to the user, and if the LAN SIM was in a particular category, the user of that “visiting” LAN SIM could then use the LAN and not the GSM network.

FIG. 6 shows schematically an embodiment of a communications system 1 in which a subscriber configures the alert provided to other users who are visiting their network. Suppose user of mobile communications device 20a has as their home network local area network 12. User of mobile communications device 20a configures alerts to be sent to inform visiting mobile communications devices 20b 20c and 20d using an appropriate computer application. In one embodiment, this application is able to operate on a mobile communications device to provide the user with means for entering or selecting the communications network identities of the users of devices 20a,b, and c (e.g., their telephone numbers or icons or other displayed identities) and for associating each identity with particular alert modes and/or files which are to be either provided to the visiting user's mobile communications devices via the communications system, or which are to be activated on the visiting user's mobile communications device if previously provided or installed. The configuration application is provided to a platform which is capable of communicating the user's selection to a remote server which receives notification from visiting mobile communications devices of any request to handover from another network to the home network, and which performs a look-up operation to determine if the identity of the user associated with the device which has generated the request to hand-over message has been associated with a specific alert. If so, then the remote platform causes the necessary data to be provided to the visiting device to enable the device to generate an alert as selected. Alerts can also be selected according to a group of identities. In this way, a user can configure their home network to play a particular announcement to “friends” which differs from those provided to “family”, and to provide a different announcement to an individual from that used for general visitors etc. A default announcement can be selected. The alert may over-ride user preferences for personalized alerts on their mobile communications devices unless the user has selected either not to override visiting device personalized alerts (which means it will only override generic alert modes of handover notification or alerts for which no “don't override” has been configured). Thus the alert provided to mobile communications device 20B may comprise a particular greeting, that to device 20C may comprise another greeting, and the user may have configured their system so that not alert at all is provided to device 20D. In this way, the user of device 20D is either not alerted to home network 12 by the subscriber of home network 12. Depending on how the communications system has been configured, this means that either device 20D may generate their own alert (for example if the user of device 20D has configured that device to recognize when they are within the local area network associated with user identity of 20A), or they may receive a network-wide default alert, or no alert at all.

In another embodiment of the invention, the alert configuration application runs on a different platform. Alternatively, this association could be done using another device, e.g. a personal computer, again user identities are either entered by the home network user or selected for example, using contact information already available on the personal computer (such as might, for example, be provided in Outlook™ etc . . . ). These embodiments enable a user to associate one or more particular user identities each with a form of alert mode, and a particular media form for the alert, in the manner mentioned herein above so that personalized alerts can be provided to individual and groups of visitors of another user's home network. Those skilled in the art will appreciate that as the mobile communications device remains operational using the WAN communications mode even when handover to another user's LAN is not successful, information can be communicated to the mobile communications device which cause a personalized alert to be generated.

Those skilled in the art will recognize that several equivalents to the features described in each embodiment exist, and that it is possible to incorporate features of one embodiment into other embodiments (for example, the features described in the context of a user may also apply when that user is the subscriber of a home LAN and vice versa etc). Accordingly, the spirit and scope of the invention is not to be confined to the specific elements recited in the description but instead is to be determined by the scope of the claims, when construed in the context of the description, bearing in mind the common general knowledge of those skilled in the art.

The text of the abstract below is hereby incorporated into the specification:

A communications system comprising a plurality of local area networks (LAN) and a wide area network (WAN). The mode of communication used in said LANs differs from the mode of communication within said WAN. One of the LANs comprises a home LAN which is associated with a user identity (e.g. a subscriber for that LAN in the communications system). The user identity is directly or indirectly also associated with a wide area network. The invention provides a method of configuring an alert to devices operated by other user identities which have performed a handover operation either into or from said home network of the subscriber. The alert is configured by said subscriber (e.g., by a user identity of the home network) either as a default to all “visitors” or in dependence on one or more of the other user identities. In this way, each user identity visiting the subscribers home network receives an alert which is capable of being specific to the visitor. The subscriber may select the form of alert to be provided to another user based individually on the other users identity in the communications network or for a group of users. The method thus enables alerts to distinguish different users or groups of users. The form of alert provided may over-ride any personal preferences configured for the mobile communications devices of the visiting users.

1. A method of providing an alert in a communications system comprising a plurality of wireless local area networks and a wide area network, said alert being provided to a mobile communications device associated with a user identity, wherein said mobile communications device is capable of operating in two modes of communication, one mode being associated with a local area network of said communications system, the other mode being associated with the wide area network of said communications system, the method comprising:
determining the presence of another wireless network within which said mobile communications device operates using a different mode of communication;
generating a handover request for performing a heterogeneous network handover either to or from a wireless local area network associated with a subscriber other than the user of the mobile communications device; and
generating a personalized alert associated with a heterogeneous network handover event on said mobile communications device.

2. A method as claimed in claim 1, wherein said heterogeneous network hand over event comprises generating said request.

3. A method as claimed in claim 1, wherein said heterogeneous network hand over event comprises completing a handover to or from said local area network.

4. A method as claimed in claim 1, further comprising the steps of:
receiving said request at a wireless router supporting said wireless local area network of said subscriber, and
processing said request to determine the identity of a requesting mobile communications device.

5. A method as claimed in claim 4, wherein, in said step of processing said request, if said request is associated with a user identity which is not the identity of the subscriber, the method further comprises the steps of:
retrieving from a data store information indicating an alert mode associated with said user identity; and
communicating information to said mobile communications device to enable said mobile communications device to generate a personalized alert.

6. A method as claimed in claim 5, wherein said information is communicated to the mobile communications device using a short-range wireless communications protocol.

7. A method as claimed in claim 5, wherein said information is communicated to the mobile communications device using a long-range wireless communications protocol.

8. A method as claimed in claim 1, wherein the alert indicates that the mobile communications device is within the area of service of a wireless local area network associated with a subscriber of a network service, wherein said subscriber's user identity differs from said user identity associated with said device, and

9. A method as claimed in claim 1, wherein said mobile communications device further comprises means to request a handover between heterogeneous networks of said communications system both on-hook and off-hook.

10. A method as claimed in claim 5, further comprising the step of said subscriber configuring said alert mode by associating an alert mode with one or more user identities in said data store.

11. A method as claimed in claim 1, wherein the form of the alert is personalized by the subscriber and is provided in the same personalized form to any mobile communications device which is within the area serviced by said local area network of the subscriber.

12. A method as claimed in claim 1, wherein the form of the alert is personalized by the subscriber and is determined by the subscriber for a specific user or group of users.

13. A method as claimed in claim 1, wherein the form of the personalized alert includes an indication of whether the subscriber has enabled said other user's mobile communications device to access one or more services of the subscriber's local area network.

14. A method as claimed in claim 1, wherein the form of the alert comprises an indication of the identity of the subscriber whose network the user is visiting.

15. A method as claimed in claim 10, wherein said configuration step comprises the steps of: the subscriber associating an alert with an identity associated with the mobile communications device of another user, whereby, when said device of said other user enters said subscriber's local area network, said alert personalized by the subscriber is provided to said other user's mobile communications device.

16. A method as claimed in claim 1, wherein said personalized alert comprises a media file, wherein when said mobile communications device generates a request for handover to said subscriber's network, said media file is executed on said mobile communications device.

17. A method as claimed in claim 16, wherein said executed media file comprises at least one form of the following media:
one or more images to be displayed on the user's device;
one or more audio files to be played on the user's device;
one or more video files to be played on the user's device; and/or
a physical response in the user's device.

18. A method as claimed in claim 16, wherein said media file is communicated to said other user's mobile communications device from a server of said subscriber over said subscriber's local area network.

19. A method as claimed in claim 1, wherein a differing alert is provided to said mobile communications device when said mobile communications device performs a handover to said local area network from said wide area network, from when said mobile communications device performs a handover from said local area network to said wide area network.

20. A communications system comprising a plurality of wireless local area networks and one or more wide area networks and a mobile communications device associated with a user identity, wherein said mobile communications device is capable of operating in two modes of communication, one mode being associated with a local area network of said communications system, the other mode being associated with a wide area network of said communications system, communications system comprising;
in said mobile communications device:
means for determining the presence of another wireless network within which said mobile communications device operates using a different mode of communication;
means for determining one or more criteria for requesting handover to said alternative wireless network are met;
means for generating a handover request for performing a heterogeneous network handover either to or from a wireless local area network associated with a subscriber other than the user of the mobile communications device; and
means for generating a personalized alert associated with a heterogeneous network handover event on said mobile communications device.

21. A mobile communications device associated with a user identity, wherein said mobile communications device is capable of operating in two modes of communication, one mode being associated with a local area network of a communications system, the other mode being associated with a wide area network of said communications system, the mobile communications device comprising;
means for determining the presence of another wireless network within which said mobile communications device operates using a different mode of communication;
means for determining one or more criteria for requesting handover to said alternative wireless network are met;
means for generating a handover request for performing a heterogeneous network handover either to or from a wireless local area network associated with a subscriber other than the user of the mobile communications device; and
means for generating a personalized alert associated with a heterogeneous network handover event on said mobile communications device.

22. A communications system, comprising a plurality of wireless local area networks, and a wireless wide area network, wherein each local area network is capable of providing an alert to a plurality of communications devices, wherein each said communications device is capable of operating in a first mode within a local area network and a second mode Within said wide area network and of handing over between at least one of said local area networks and said wide area network, the communications system further comprising:
means to send and receive communications to users' mobile communications devices in said local area networks and said wide area network,
means to process handover requests received from a user's mobile communications device when said mobile communications device seeks to perform a handover in either direction between said wide area network and a said wireless local area network associated with a subscriber;
means to identify a local area network associated with said handover request;
means to determine an identity for the user of the mobile communications device;
means to communicate said identity to the router for said local area network associated with said handover request; means to determine if an alert to be communicated to said mobile communications device has been configured on said router, and if so, to communicate said alert to said device,
wherein the form of said alert to said user identity is determined by said subscriber and stored at a location accessible to said router for said subscriber's local area network.

23. A computer application arranged to provide personalized alert information to a user operating a mobile communications device in a local area network associated with a subscriber to a communications system as claimed in claim 20 wherein the application is arranged to enable the subscriber to select one or more differing kinds of announcement to alert each user of a visiting mobile communications device in dependence on the identity of the user, wherein said application enables an association to be formed between said identity, said home network of the subscriber, and the form of alert selected by the subscriber for said user.

24. A computer application as claimed in claim 23, which is distributed over a plurality of platforms in a communications system comprising:
a user interface arranged to enable the subscriber to select an alert in association with another user's identity, and
means to communicate said subscriber selected alert association to a remote platform of said communications system,
wherein when a request to perform a network handover from a mobile communications device of said other user is received at a remote platform of said communications system, said remote platform causes said alert to be communicated to said mobile communications device of said user.

25. A computer application as claimed in claim 24, wherein said selection means is provided on said mobile communications device of said subscriber and information on a selected association of user identity and alert mode is communicated to said first platform by said mobile communications device of the subscriber using a wireless communications network.

26. A computer application as claimed in claim 23, wherein said first platform is arranged to communicate said alert configuration to said remote platform over a fixed-line communications link.

27. A computer application as claimed in claim 23, wherein said user's identity is determined by a telephone type number or identity which is associated with an alert configuration by said subscriber of said home network.

28. A mobile communications device capable of adopting two modes of wireless communication in a communications system, one of said modes being associated with a wide area network, the other of said modes being associated with a local area network, wherein the device further comprises means to request and perform a handover between said two modes of communication when both on and off-hook, and wherein when said device generates a request to handover between said local area and wide area networks, said request event causes an alert to be provided to a user of said device, wherein the mode of the alert has been configured by a different user, whose identity is associated with said local area network between which said handover has been requested.

29. A mobile communications device as claimed in claim 28, wherein the method of providing the alert.

30. A mobile communications device as claimed in claim 28, wherein means for generating said alert mode are first communicated to the device using said local area network between which said handover to or from said wide area network has been requested.

31. A mobile communications device as claimed in claim 28 wherein said alert mode generated when said device hands over to said local area network is different from the alert mode generated when said device hands over from said local area network.

32. A mobile communications device as claimed in claim 28, wherein said device further comprises alert configuration means arranged to configure said alert information to be provided to one or more other users of other devices when said one or more other users are within a local area network of a subscriber.

33. A mobile communications device as claimed in claim 28 wherein said alert configuration means comprises an application arranged to be executed on a mobile communications device of the subscriber, said application being arranged to enable the subscriber to generate an alert association associating a form of alert with an identification of another user of said communications system, whereby said selected form of alert is sent to the other user when a mobile communications device of said other user has handed over to or from the home network of said subscriber, said application being further arranged to communicate said alert configuration means over said communications system to a server via a router for said local area network, wherein said alert configuration means associates said alert configuration with handover events associated with said home network.

34. A server arranged to provide alert information to a mobile communications device via a wireless communications network router, when the mobile communications device has handed over from a first type of wireless communications network to a second type of wireless communications network associated with said router, wherein said alert information which is communicated to the device of a user over said second type of communications network comprises an alert which has been configured by a subscriber to said second type of communications network using an application as claimed in claim 23.

35. A signal communicated from a router associated with a local area network in a communications system comprising a plurality of wireless local area networks and a wireless wide area network, wherein the signal is received by a mobile communications device operated by a user in said communications system, said mobile communications device being capable of performing a handover between at least one said local area networks and said wide area network, and said device further comprises means to send and receive communications in a communications mode used by said local area networks and a communications mode used by said wide area network, wherein
said signal enables an alert to be generated by said mobile communications device to alert the user to the fact that a handover to or from the local area network has been performed or requested, the mode of the alert having been determined by a user associated with said local area network.
